(19) United States
(12) Patent Application Publication
(10) Pub. No.: US 2025/0129806 A1
(43) Pub. Date: Apr. 24, 2025

(54) ACTUATOR ASSEMBLY

(71) Applicant: Goodrich Actuation Systems SAS, Vernon (FR)

(72) Inventors: Hippolyte MARRANT, Paris (FR); Dominique POULET, Épiais-lès-Louvres (FR)

(21) Appl. No.: 18/915,684

(22) Filed: Oct. 15, 2024

(30) Foreign Application Priority Data
Oct. 23, 2023 (EP) 23306857.6

(51) Int. Cl. F15B 15/14

(52) U.S. Cl. CPC F15B 15/14

(57) ABSTRACT

An actuator assembly includes an actuator control block formed of a first material. The assembly further includes two or more tie rods, a tailstock and a front plate. The two or more tie rods, the tailstock and the front plate are formed of a second material able to withstand more tensile stress than the first material.

### CROSS-REFERENCE TO RELATED APPLICATIONS

This application claims the benefit of European Patent Application No. 23306857.6 filed Oct. 23, 2023, the disclosure of which is incorporated herein by reference in its entirety.

### TECHNICAL FIELD

The present disclosure is concerned with actuators having a movable rod and a control block, e.g. hydraulic actuators having a ram rod and a hydraulic block for causing movement of the rod.

### BACKGROUND

Actuators are used in a wide variety of fields and applications for moving parts or surfaces from one position to another. Actuators are commonly used, for example, in aircraft, for moving flight control surfaces or aircraft parts, doors etc. Many types of actuator are known, including mechanical, hydraulic and electrical actuators and combinations thereof e.g. electro-hydrostatic actuators, EHAs. An actuator typically has an actuator housing, or cylinder, also known as a ram body, within which an actuator ram or rod is located for axial movement relative to the housing. The rod is moved by application of power to one end of the rod. The other end of the rod is connected to a surface or part to be moved. Power is applied to the rod according to the type of actuator. In some actuators (hydraulic, EHA, etc.) the rod is moved by the application of hydraulic fluid provided from a hydraulic assembly in a hydraulic block. The hydraulic block is assembled to the actuator housing.

Because the actuator rod and ram body are typically subjected to high levels of mechanical stress, they typically need to be made of a strong material capable of withstanding such stresses, especially tensile stresses, such as steel. On the other hand, such materials are relatively expensive and heavy and it is usually desirable to reduce the overall weight and cost of an actuator assembly. In aircraft, in particular, the weight of aircraft parts should be minimised where possible, for reasons of efficiency. To reduce the overall weight and cost of the actuator assembly, therefore, whilst maintaining the strength of the rod, it is common to fabricate the control block e.g. the hydraulic block, of a lighter material such as aluminium or, for higher pressure applications, titanium. Aluminium is not suitable for withstanding the high mechanical tensile stresses applied to the rod, and so cannot be used for that part. The actuator assembly, therefore, typically is formed as two separate main structural parts, made of different materials, that are then assembled together.

Such assemblies, however, are still relatively heavy, expensive and complex, and require relatively time-consuming assembly. There is, therefore, a desire for simpler, less expensive, lighter actuator assemblies.

### SUMMARY

According to the disclosure, there is provided an actuator assembly comprising: an actuator cylinder, and an actuator control block, wherein the actuator cylinder and the control block are formed integrally of a first material, e.g. aluminium; the assembly further comprising two or more tie rods spanning a part of the cylinder, a front plate and a tailstock, the two or more tie rods, front plate and tailstock being formed of a second material, e.g. steel, able to withstand more tensile stress than the first material.

A method of making an actuator assembly is also provided.

### BRIEF DESCRIPTION

Examples of an actuator assembly according to this disclosure will now be described with reference to the drawings. It should be noted, that variations are possible within the scope of the claims.

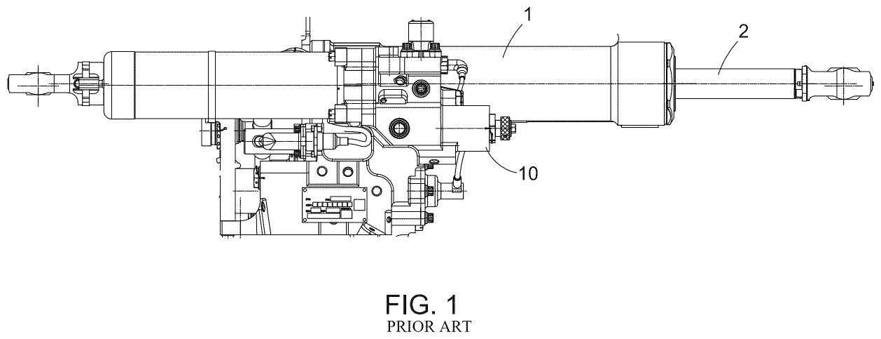

FIG. 1 shows a typical actuator assembly architecture.

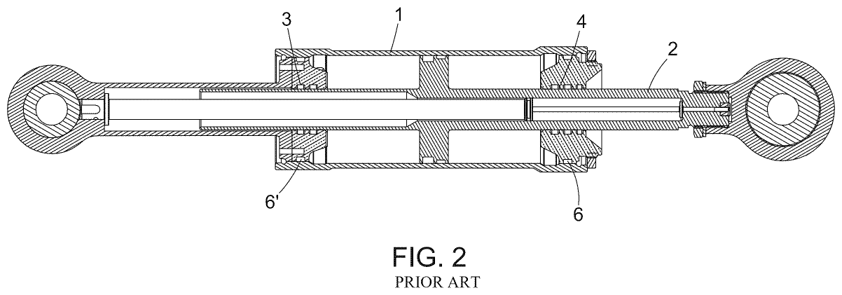

FIG. 2 shows a cross-section of a typical power line assembly such as shown in FIG. 1.

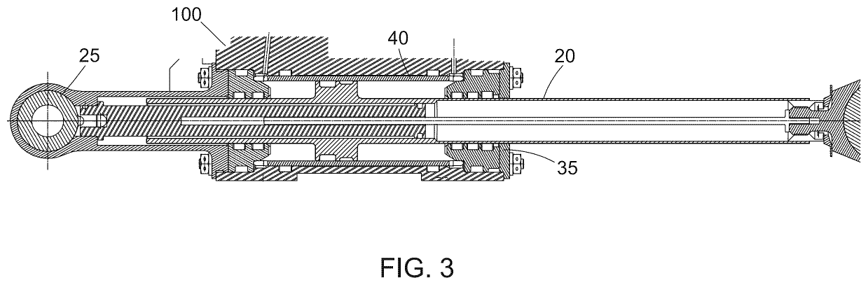

FIG. 3 shows a cross-section of a power line assembly according to this disclosure.

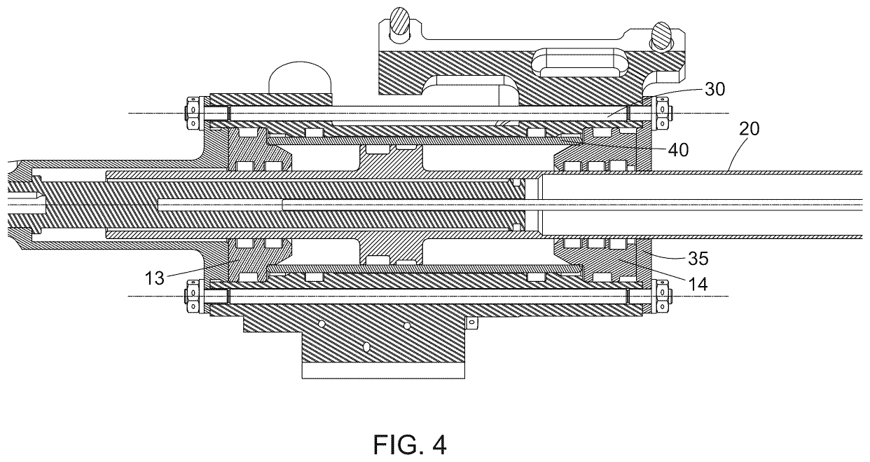

FIG. 4 shows a detail of a power line assembly such as shown in FIG. 3.

### DETAILED DESCRIPTION

The conventional actuator architecture shown in FIGS. 1 and 2 will be briefly described by way of background. The assembly will not be described in detail, since such actuators are well-known.

The actuator comprises an actuator housing or cylinder, also known as a ram body 1 mounted to a control block 10—here a hydraulic block. A ram or piston rod 2 is slidably located within the cylinder 1, and moves relative to the cylinder responsive to the application of hydraulic fluid from the block. The rod 2 slides on bearings 3, 4 which support the rod relative to the cylinder but allow the relative axial movement. Seals 6, 6′ are also provided to prevent the leakage of hydraulic fluid from the assembly. The sealing between the piston head and the ram body, providing sealing between the two chambers, is ensured by a special surface treatment or finish on the ram body main bore, coupled with an adapted sealing system fitted on the piston head.

As mentioned above, due to the high mechanical stresses to which it is subjected, especially traction, the cylinder needs to be made of a strong material that can withstand such stresses, e.g. steel. To minimise overall weight and cost, however, the control block 10, which is only subjected to hydraulic stress, is made of a lighter material such as aluminium or titanium. This results in a relatively complex and expensive two-part assembly that still has a heavy actuator rod.

In the assembly according to the disclosure, examples of which will be described with reference to FIGS. 3 and 4, the cylinder is integrated into the control block 100 and is made of the same material as the control block e.g. aluminium.

Of course, this does mean that the strength of the cylinder is reduced relative to the known assemblies and so the assembly requires modification to add the strength required to withstand the tensile stresses to which the power line assembly is subjected. To achieve the required strength, two or more tie rods 30 are provided to link or connect the two attachment points of the power line through the tailstock 25, the body 100 and the front plate 35. The two or more tie rods are made of a stronger material that can withstand the tensile stresses, e.g. steel. The tie rods are tightened using an adapted nut assembly. Thus, rather than the entire body of the cylinder needing to be made of e.g. steel, the main part of the body can be made of e.g. aluminium, like the block 100, and strength is provided by the two or more tie rods. In the example shown, four tie rods 30 are provided linking/connecting the tailstock 25, the body 100 and the front plate 35. If needed to ensure sealing between the two chambers, a sleeve 40 can be included in the assembly. If needed, this part is made of a different material to that of the hydraulic block, and has a special finish or surface treatment.

In the preferred arrangement, parts of the assembly that are particularly subjected to stresses, especially tensile stresses, e.g. the rear part (or tailstock) 25 are made of the stronger material and/or front plates 35 at the other end of the cylinder are also made of the stronger material.

As with the known assembly, bearings 13, 14 are provided between the rod and the cylinder. The sleeve 40 may be provided between the rod and the cylinder to guide and seal against leakages. Other forms of seal may also be used.

The traction load path through the assembly is distributed between the rod through the front bearing 14 through the front plates 35, through the tie rods assembly 30 and, through the steel tailstock 25.

By merging the ram body/cylinder with the control block e.g. hydraulic block, forming them of the same, lighter material e.g. aluminium, cost and weight is minimised. The required strength of the rod is provided by means of the tie rods made of a stronger material, e.g. steel. As the ram body and the control block are integrated, they are supplied as a single component, which simplifies assembly and supply chain.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An actuator assembly comprising:
an actuator control block, wherein the control block is formed of a first material;
two or more tie rods;
a tailstock; and
a front plate;
wherein the two or more tie rods, the tailstock and the front plate are formed of a second material able to withstand more tensile stress than the first material.

2. The assembly of claim 1, further comprising:
nuts to tighten the tie rods.

3. The assembly of claim 2, further comprising:
bearings between the rod and a rod housing within which the rod moves.

4. The assembly of claim 1, wherein the first material is aluminium.

5. The assembly of claim 4, wherein the second material is steel.

6. The assembly of claim 1, wherein the second material is steel.

7. The assembly of claim 1, further comprising:
a sleeve between the rod and a rod housing within which the rod moves.

8. A method of making an actuator assembly comprising;
integrally forming an actuator control block of a first material; and
providing two or more tie rods, a tailstock and a front plate;
wherein the two or more tie rods, the tailstock and the front plate are formed of a second material capable of withstanding higher tensile stresses than the first material.

9. The method of claim 8, further comprising:
tightening the tie rods with a nut assembly.

10. The method of claim 8, further comprising:
disposing bearings between the rod and a rod housing within which the rod moves.

11. The method of claim 8, wherein the first material is aluminium.

12. The method of claim 11, wherein the second material is steel.

13. The method of claim 8, wherein the second material is steel.
